(19) United States
(12) Patent Application Publication
(10) Pub. No.: US 2009/0249401 A1
(43) Pub. Date: Oct. 1, 2009

(54) Facilitating interactive functionality for a community of mind in association with delivery of televised content

(75) Inventors: Sylvain Squedin, Bondoufle (FR); Emmanuel Marilly, Saint Michael sur Orge (FR); Bertrand Boidart, Guyancourt (FR); Alexandre Vanbelle, Steenvoorde (FR)

Correspondence Address: ALCATEL-LUCENT, C/O GALASSO & ASSOCIATES, LP, P. O. BOX 26503, AUSTIN, TX, 78755-0503, US

(73) Assignee: ALCATEL LUCENT

(21) Appl. No.: 12/080,072

(22) Filed: Mar. 31, 2008

(51) Int. Cl. H04N 5/445; H04N 7/173

(52) U.S. Cl. 725/46; 725/86; 725/93

(57) ABSTRACT

A method for providing interactive functionality in conjunction with delivery of televised content has a plurality of operations. An operation is performed for receiving a request from a television service subscriber. The request communicates a desire of the television service subscriber for being provided interactive subscriber functionality in conjunction with the subscriber viewing televised content. An operation is performed for associating the subscriber with a community of other subscribers in response to receiving the request. Such associating is performed dependent upon the televised content and profile information of the subscriber and the televised content is accessible by all of the other subscribers. In response to performing such associating, an operation is performed for offering interactive functionality to the subscriber. The interactive functionality corresponds to the televised content and is selected from available interactive functionality dependent upon the televised content.

### FIELD OF THE DISCLOSURE

The disclosures made herein relate generally to facilitating interactive functionality for recipients of televised content and, more particularly, to facilitating such subscriber interactivity dependent upon such recipients sharing a common content interest and a common television program and/or television service.

### BACKGROUND

It is known that subscribers to a television (TV) program service find desirability, if not value, in content and services that offer interactive functionality. It is also well know that there have been various approaches presented for offering such interactive functionality with respect to TV program services. Examples of such interactive functionality include, but are not limited to, chat sessions, gaming sessions, direct advertising, and the like.

Existing approaches for providing interactive functionality via TV program services are configured for managing a set of users (i.e., service subscribers) located near to a specific location. A location where a set top box used by the set of users is located is an example of such a specific location. Such a set of users at such a specific location is referred to herein as a community of location. The community of location represents a group of persons (i.e., subscribers) sharing a common relative location and common TV programming and/or service. For example, a set-top box system readily enables creation and management of a community of location.

The community of location offers various ways to present and/or consume interactivities between users of the community. The relatively close proximity of the users in the community promotes the creation of local interactivity that is bound by common TV program content. The manager of a community of location (e.g. a manager hosted in a set-top box or cellular phone infrastructure) proposes interactive services according to the current TV program content. However, facilitating interactivity within a community of location setting is lacking in that common interests of the users do not bind such interactivity. This lack of binding by common interests adversely impacts interactivity among persons within a community of location.

Therefore, facilitating a TV program service in a manner that provides for interactive functionality for a community of users and in a manner that binds the community of users via one or more common interests irrespective of location of such users would be advantageous, desirable and useful.

### SUMMARY OF THE DISCLOSURE

Embodiments of the present invention facilitate a subscriber-based TV program service in a manner that provides for interactive functionality for a community of service subscribers and in a manner that binds the community of service subscribers via one or more common interests irrespective of location of such subscribers and without inherent limitations associated with location. Such a community of service subscribers, which is bound via one or more common interests and televised content (e.g., a television program) or service, is referred to herein as a community of mind. For example, the community of mind can include several subscribers watching the same televised content or using the same TV subscriber service in different locations and sharing the common interest. In view of being bound via one or more common interests and televised content or service, interactive functionality can be facilitated for a community of mind in a manner that is advantageously distinguished with respect to conventional approaches for facilitating interactive functionality in combination with televised content.

In one embodiment of the present invention, a method for providing interactive functionality in conjunction with the delivery of televised content comprises a plurality of operations. An operation is performed for receiving a request from a television service subscriber. The request communicates a desire of the television service subscriber for being provided interactive subscriber functionality in conjunction with the subscriber viewing televised content. An operation is performed for associating the subscriber with a community of other subscribers in response to receiving the request. Such associating is performed dependent upon the televised content and profile information of the subscriber and the televised content is accessible by all of the other subscribers. In response to performing such associating, an operation is performed for offering interactive functionality to the subscriber. The interactive functionality corresponds to the televised content and is selected from available interactive functionality dependent upon the televised content.

In another embodiment of the present invention, a data storage device has a set of processor-executable instructions stored thereon. The set of processor-executable instructions comprise instructions for receiving a request from a television service subscriber for being provided interactive subscriber functionality in conjunction with the subscriber viewing televised content, instructions for associating the subscriber with a community of other subscribers in response to receiving the request, and instructions for offering interactive functionality to the subscriber in response to performing the associating. Such associating is performed dependent upon the televised content and profile information of the subscriber. The televised content is accessible by all of the other subscribers. The interactive functionality corresponds to the televised content and is selected from available interactive functionality dependent upon the televised content.

In another embodiment of the present invention, an application server comprises a community manager and a subscriber services manager. The community manager is configured for interpreting a request from a television service subscriber for being provided interactive subscriber functionality in conjunction with the subscriber viewing televised content and for associating the subscriber with a community of other subscribers dependent upon televised content and profile information of the subscriber. The televised content is accessible by the subscriber and all of the other subscribers. The subscriber services manager is configured for selecting interactive functionality from available interactive functionality dependent upon the televised content in response to the community manager associating the subscriber with the community, for offering the interactive functionality to the subscriber in response to performing the associating, and for synchronizing presentation of the televised content with the interactive functionality whereby the televised content and the interactive functionality are presented in a time-dependent manner with respect to each other. The interactive functionality corresponds to the televised content and is selected from available interactive functionality dependent upon the televised content.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a diagrammatic view showing a community of mind schematic in accordance with an embodiment of the present invention;

FIG. 2 is a flow chart showing a method for facilitating interactive functionality in conjunction with televised content in accordance with an embodiment of the present invention; and

FIG. 3 is a block diagram showing a system configured for facilitating interactive functionality in conjunction with televised content in accordance with an embodiment of the present invention.

### DETAILED DESCRIPTION OF THE DRAWING FIGURES

Embodiments of the present invention provide a solution for creating and managing a community of mind as opposed to a community of location. The community of mind can include several subscribers (i.e., community members) watching a common TV program and/or using the same subscription service in different locations and sharing a common interest. Thus, a community of mind is bound by common interest (e.g. TV program or service) irrespective of a location of the subscribers.

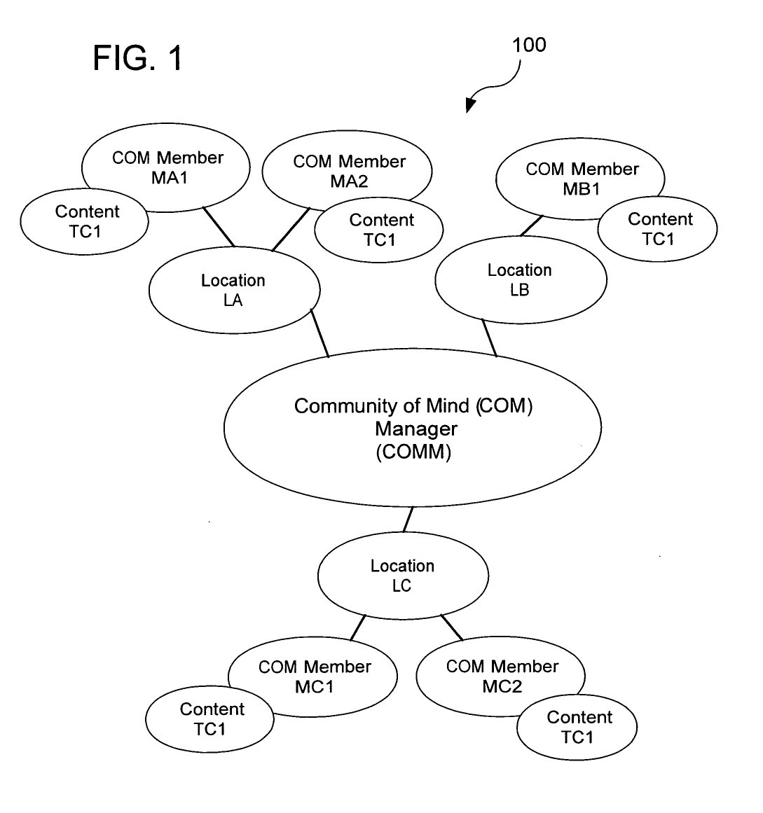

Referring to FIG. 1, a community of mind schematic 100 in accordance with an embodiment of the present invention is shown. A community of mind (COM) includes a plurality of members (MA1-MC2). Thus, these members are referred to herein as COM members. All of the COM members (MA1-MC2) are accessing common televised content (TC1), which is one example of a common interest that binds the COM members (MA1-MC2) within the COM. It is disclosed herein that one or more additional common interests relating to the common televised content (TC1) can also serve to further bind the COM members (MA1-MC2) within the COM.

A community of mind (COM) manager COMM interacts with the COM members (MA1-MC2). As is discussed below in greater detail, the COM manager (COMM) facilitates interactive functionality dependent upon one or more criterion specific to the COM. Examples of such interactive functionality include, but are not limited to, supplemental information communication, member document publishing (e.g., BLOGS), chat room discussions, forum discussions, gaming, etc. The COM manager (COMM) can be hosted in a set-top box, cellular telecommunications network or the like, proposing interactive functionality (i.e., services) according to the TV program content, subscriber interests and the like. In this manner, the COM manager (COMM) can provide specific services and functions to the COM dependent upon the televised content, thereby allowing members thereof to communicate, play, share, exchange, game, etc according to common televised content and, optionally, other common interests.

A first portion of the COM members (MA1, MA2) are located at a first location (LA), a second portion of the COM members (MB1) is located at a second location (LB) and a third portion of the COM members (MC1, MC2) are located at a third location (LC). The locations (LA, LB, LC) are not limited to a certain resolution of distinction. More specifically, the locations can be different locations from a subscriber premise perspective (e.g., different location in a building structure), different locations from a city perspective, different locations from a state perspective, different locations from a country perspective and the like. Thus, it is disclosed herein that respective locations of members of a community of mind in accordance with an embodiment of the present invention are essentially boundless so long as a member has access to televised content being accessed by other members of the community.

### Example 1

### Watched Event

A football match is watched by a lot of persons. These persons can watch it with their own TV (home), watch it on a common TV (e.g., in a shop or pub), or directly in the stadium, for example. These persons are bound by the common content (i.e., the football match). It can be seen that two or three groups bound by the common interest can be created. These groups are: supporters of a first club, supporters of a second club, and persons watching with preference to neither club. Functionality configured in accordance with the present invention can create two or three communities of mind according to the user profile (e.g., user demographic, special interests, etc), policy rules and/or defined preferences, and propose associated services (i.e., interactive functionality) such as, for example, club-specific information exchange, club-specific news, games to win a ticket for a next match, etc. Accordingly, interactive functionality can be provided to the service subscribers dependent upon common interest(s) irrespective of location.

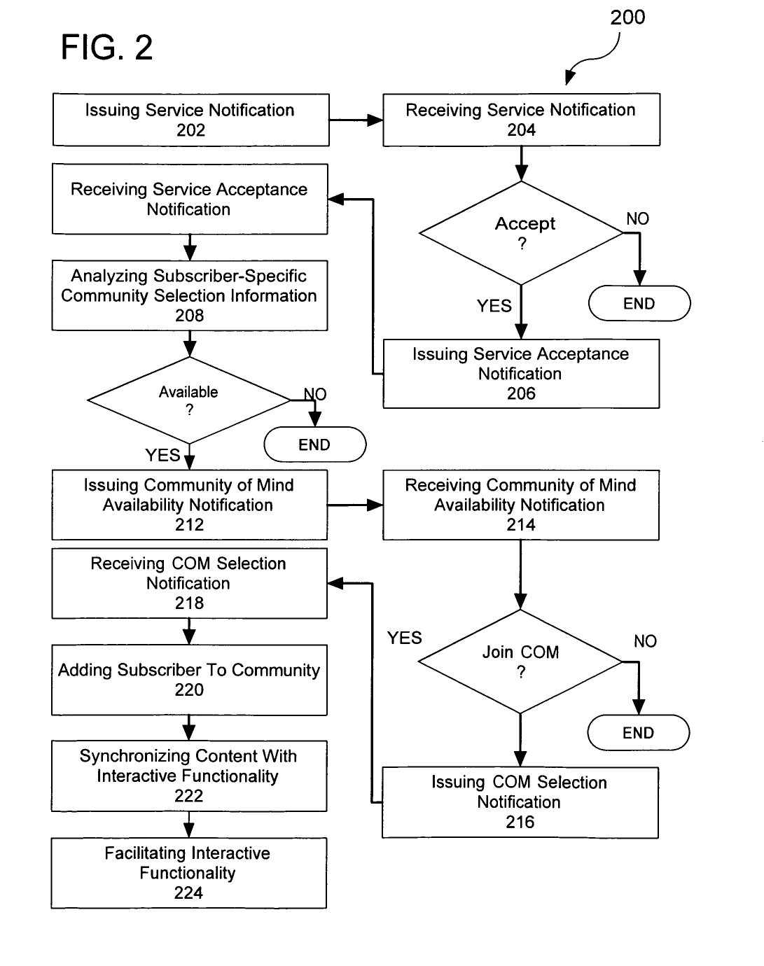

Turning now to FIG. 2, a method 200 for facilitating interactive functionality in conjunction with televised content in accordance with an embodiment of the present invention is shown. The method 200 begins with an operation 202 for issuing a service notification (e.g., from a subscriber services manager for reception by a content access device). The service notification offers interactive functionality through membership in one or more communities of mind. In response to performing an operation 204 for receiving the service notification and in response to the service subscriber accepting the offer (manually or automatically via prescribed settings), an operation 206 is performed (e.g., by the content access device) for issuing a service acceptance notification. If the service subscriber declines the offer, the method 200 ends after the operation 204 for receiving the service notification.

After performing an operation 208 for receiving the service acceptance notification (e.g., by a subscriber services manager or a community manager), an operation 210 is performed for analyzing subscriber-specific community of mind selection information (e.g., by the subscriber services manager or the community manager). In one embodiment, analyzing such subscriber-specific community of mind selection information includes accessing information that allows a determination to be made as to whether a community of mind that corresponds to interests of the service subscriber (e.g., the televised content and optionally other preferences/criteria) exists or can be created. Examples of such information through which the determination can be made include, but are not limited to, subscriber profile information (e.g., interests, community history, etc), community profile information (e.g., members, associated program content, etc), program content information (type of program, televising information, etc).

In response to one or more communities of mind existing or being creatable that correspond to the televised content and requisite service subscriber criteria, an operation 212 is performed for issuing a community of mind availability notification (e.g., by the subscriber services manager or the community manager for reception by the content access unit). If one or more communities of mind that correspond to the televised content and requisite service subscriber criteria do not exist or cannot be created, the method 200 ends after analyzing the subscriber-specific community of mind selection information. After performing an operation 214 for receiving the community of mind availability notification and in response to the service subscriber deciding to join an available community of mind, an operation 216 is performed for issuing a COM selection notification (e.g., by the content access device). After performing an operation 218 for receiving the COM selection notification, an operation 220 is performed for adding the service subscriber to the selected community of mind (i.e., associating the service subscriber with the community of mind), followed by an operation 222 being performed facilitating interactive functionality (e.g., by the subscriber services manager or the community manager).

It is disclosed herein that, in at least one embodiment of the present invention, associating the service subscriber with a community of mind is performed dependent upon an interest (e.g., a special interest such as relating to a hobby, profession, life experience, etc) shared by the subscriber and other subscribers (i.e., potential community members). Furthermore, it is disclosed herein that, in at least one embodiment of the present invention, the televised content has information relating to the special interest incorporated therein. Further, it is disclosed herein that, in at least one embodiment of the present invention, associating the service subscriber with a community of mind includes accessing the subscriber profile information to identify a special interest of said subscriber and selecting the other members dependent upon the special interest and from a collection of available members currently having said televised content being transmitted for reception thereby. Still further, it is disclosed herein that, in at least one embodiment of the present invention, facilitating interactive functionality can include synchronizing the televised content with various components of the corresponding interactive functionality. Alternatively, such synchronization can be performed independently of (e.g., prior to) facilitating the interactive functionality. The service subscriber can at any time select a community proposed to join or leave one to leave, and can also create a community and send a membership invitation to other service subscribers.

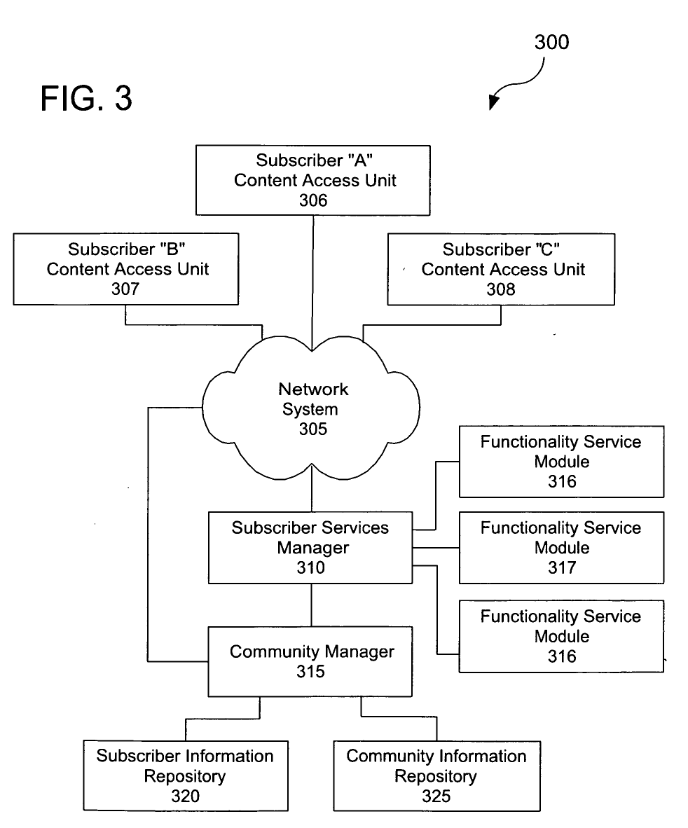

Referring now to FIG. 3, a system 300 configured for facilitating interactive functionality in conjunction with delivery of televised content in accordance with an embodiment of the present invention is shown. The system 300 is one example of a system configured for carrying out the method 200 disclosed herein. The system 300 includes a network system 305 coupled between content access units of a plurality of service subscribers (i.e., content access unit 306, 307 308) and a subscriber services manager 310. Examples of content access units include, but are not limited to, television set top boxes, telephones, computers and any other device or equipment configured for receiving televised content. A community manager 315 is coupled to network system 305 and to the subscriber services manager 310. The subscriber services manager 310 facilitates management of application and services associated with facilitating interactive functionality in accordance with embodiments of the present invention. A plurality of functionality service modules (316, 317 and 318) are coupled to the subscriber services manager 310. A subscriber information repository 320 and a community information repository 325 are coupled to the community manager 315.

The content access unit (306-308), which can be embedded in equipment such as a set top unit, cellular telephone or other type of equipment configured for accessing televised content, are not bound to particular respective locations with respect to each other. The functionality service modules (316, 317 and 318) each provide a respective type of interactive functionality. Through the network system 305, the content access unit (306, 307 308) and the subscriber services manager 310 are able to interact (e.g., communicate information therebetween) for allowing interactive functionality in accordance with the present invention to be facilitated.

It is disclosed herein that the functionality service modules (316, 317 and 318) are not limited to a particular logical implementation. For example, the functionality service modules (316, 317 and 318) can be individual modules, can be common both physically and logically, can be integral with the subscriber services manual 310, etc. Similarly, it is disclosed herein that the subscriber information repository 320 and the community information repository 325 are not limited to a particular data structure/storage implementation. For example, the subscriber information repository 320 and the community information repository 325 can be individual databases on discrete data storage units, can be separate databases on the same data storage unit, can be separate portions of a single database, etc.

An Internet protocol Multimedia Subsystem (IMS) network is one example of the network system 305. In one embodiment, the MS network has a plurality of proxy call session control functions (CSCF) for facilitating communication with various use devices, a serving CSCF immediately adjacent the community services manager for facilitating communication therewith and an interrogating CSCF coupled between the proxy CSCFs and the serving CSCF. However, embodiments of the present invention are not unnecessarily limited to a particular configuration of network system.

In one embodiment, each content access unit (306-308) can includes a user agent module that allows downloading of applications, if needed such as for a Personal Digital Assistance (PDA). Another functionality that such a user agent allows is seamless configuration of the downloaded application. Still another functionality that such a user agent allows is managing of a subscriber's interaction between the application and the subscriber.

With respect to a specific implementation of the system 300, one of the content access units (306-308) detects a TV program selection (i.e., televised content) as selected by the corresponding service subscriber. After several seconds (i.e., a configurable timeframe), the detecting content access unit (e.g. a set top box) sends a message to the community selection manager 315. The community selection manager 315 is configured for defining/selecting and proposing to the detecting content access unit one or more communities of mind according to the current TV program and to an accessed profile of the service subscriber (e.g., can support a common profile, a family profile, etc). Next, the detecting content access unit(s) and the community manager 315 communicate for facilitating registration of the respective service subscriber(s) to a selected community of mind using an automatic or dynamic approach thereby defining a community of mind in which the detecting content access unit (i.e., and its service subscriber) is a member. Thereafter, the system 300 facilitates synchronization of the TV program selection via the subscriber services manager 310, which also selects the appropriate application or service corresponding to current TV program selection and, optionally, other interests of the selected community of mind which can include basic communities mechanism (chat, gaming, etc). A system in accordance with an embodiment of the present invention can create several segments (sub-community) in a given community of mind. In fact, such a system can creates a default community of mind corresponding to a current TV program selection, while also creating in the given community of mind an embedded community corresponding to a user profile (e.g. a given age range, a location of a community, etc).

Referring now to instructions processible by a data processing device, it will be understood from the disclosures made herein that methods, processes and/or operations adapted for carrying out interactive television content functionality as disclosed herein are tangibly embodied by computer readable medium having instructions thereon that are configured for carrying out such functionality. In one specific embodiment, the instructions are tangibly embodied for carrying out the method 200 disclosed above. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon a computer program (i.e., instructions) adapted for carrying out interactive television content functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for providing interactive functionality in conjunction with delivery of televised content, comprising:
receiving a request from a television service subscriber for being provided interactive subscriber functionality in conjunction with said subscriber viewing televised content;
associating said subscriber with a community of other subscribers in response to receiving the request, wherein said associating is performed dependent upon said televised content and profile information of said subscriber and wherein said televised content is accessible by all of said other subscribers; and
offering interactive functionality to said subscriber in response to performing said associating, wherein said interactive functionality corresponds to said televised content and is selected from available interactive functionality dependent upon said televised content.

2. The method of claim 1, further comprising:
synchronizing presentation of said televised content with said interactive functionality whereby said televised content and said interactive functionality are presented in a time-dependent manner with respect to each other

3. The method of claim 1 wherein:
said associating is performed dependent upon a special interest shared by said subscriber and said other subscribers; and
said televised content has information relating to the special interest incorporated therein.

4. The method of claim 1 wherein said associating includes:
accessing said subscriber profile information to identify a special interest of said subscriber; and
selecting said other members dependent upon the special interest and from a collection of available members currently having said televised content being transmitted for reception thereby.

5. The method of claim 4 wherein:
said associating includes selecting the community from a plurality of existing communities; and
said other members all share the special interest.

6. The method of claim 1 wherein said associating includes:
identifying a special interest of said subscriber maintained within said subscriber profile information;
selecting said other members dependent upon the special interest from a collection of available members currently having said televised content being transmitted for reception thereby; and
designating said subscriber and said other subscribers as a community jointly bound by said televised content and the special interest.

7. The method of claim 1 wherein said associating includes:
identifying a special interest of said subscriber maintained within said subscriber profile information;
identifying an existing community of subscribers jointly bound by said televised content and the special interest thereby identifying the community of other subscribers; and
adding said subscriber as a member of the existing community thereby creating a community of other subscribers.

8. A data storage device having a set of processor-executable instructions stored thereon, the set of processor-executable instructions comprising:
instructions for receiving a request from a television service subscriber for being provided interactive subscriber functionality in conjunction with said subscriber viewing televised content;
instructions for associating said subscriber with a community of other subscribers in response to receiving the request, wherein said associating is performed dependent upon said televised content and profile information of said subscriber and wherein said televised content is accessible by all of said other subscribers; and
instructions for offering interactive functionality to said subscriber in response to performing said associating, wherein said interactive functionality corresponds to said televised content and is selected from available interactive functionality dependent upon said televised content.

9. The data storage device of claim 1, further comprising:
instructions for synchronizing presentation of said televised content with said interactive functionality whereby said televised content and said interactive functionality are presented in a time-dependent manner with respect to each other

10. The data storage device of claim 8 wherein:
said associating is performed dependent upon a special interest shared by said subscriber and said other subscribers; and
said televised content has information relating to the special interest incorporated therein.

11. The data storage device of claim 8 wherein said associating includes:
accessing said subscriber profile information to identify a special interest of said subscriber; and
selecting said other members dependent upon the special interest and from a collection of available members currently having said televised content being transmitted for reception thereby.

12. The data storage device of claim 10 wherein:
said associating includes selecting the community from a plurality of existing communities; and
said other members all share the special interest.

13. The data storage device of claim 9 wherein said associating includes:
identifying a special interest of said subscriber maintained within said subscriber profile information;
selecting said other members dependent upon the special interest from a collection of available members currently having said televised content being transmitted for reception thereby; and
designating said subscriber and said other subscribers as a community jointly bound by said televised content and the special interest.

14. The data storage device of claim 9 wherein said associating includes:
identifying a special interest of said subscriber maintained within said subscriber profile information;
identifying an existing community of subscribers jointly bound by said televised content and the special interest thereby identifying the community of other subscribers; and
adding said subscriber as a member of the existing community thereby creating a community of other subscribers.

15. An application server, comprising:
a community manager configured for interpreting a request from a television service subscriber for being provided interactive subscriber functionality in conjunction with said subscriber viewing televised content and for associating said subscriber with a community of other subscribers dependent upon televised content and profile information of said subscriber, wherein said televised content is accessible by said subscriber and all of said other subscribers; and
an subscriber services manager configured for selecting interactive functionality from available interactive functionality dependent upon said televised content in response to the community manager associating said subscriber with the community, for offering said interactive functionality to said subscriber in response to performing said associating and for synchronizing presentation of said televised content with said interactive functionality whereby said televised content and said interactive functionality are presented in a time-dependent manner with respect to each other, wherein said interactive functionality corresponds to said televised content and is selected from available interactive functionality dependent upon said televised content.

16. The server of claim 15 wherein:
said associating is performed dependent upon a special interest shared by said subscriber and said other subscribers; and
said televised content has information relating to the special interest incorporated therein.

17. The server of claim 15 wherein said associating includes:
accessing said subscriber profile information to identify a special interest of said subscriber; and
selecting said other members dependent upon the special interest and from a collection of available members currently having said televised content being transmitted for reception thereby.

18. The server of claim 17 wherein:
said associating includes selecting the community from a plurality of existing communities; and
said other members all share the special interest.

19. The server of claim 15 wherein said associating includes:
identifying a special interest of said subscriber maintained within said subscriber profile information;
selecting said other members dependent upon the special interest from a collection of available members currently having said televised content being transmitted for reception thereby; and
designating said subscriber and said other subscribers as a community jointly bound by said televised content and the special interest.

20. The server of claim 15 wherein said associating includes:
identifying a special interest of said subscriber maintained within said subscriber profile information;
identifying an existing community of subscribers jointly bound by said televised content and the special interest thereby identifying the community of other subscribers; and
adding said subscriber as a member of the existing community thereby creating a community of other subscribers.
